(19) United States
(12) Patent Application Publication
(10) Pub. No.: US 2020/0030799 A1
(43) Pub. Date: Jan. 30, 2020

(54) MICROFLUIDICS VALVE

(71) Applicant: CONSEJO SUPERIOR DE INVESTIGACIONES CIENTIFICAS (CSIC), Madrid (ES)

(72) Inventors: Antonio BALDI COLL, Barcelona (ES); María DÍAZ GONZÁLEZ, Barcelona (ES); César FERNÁNDEZ SÁNCHEZ, Barcelona (ES); Francesc Xavier MUÑOZ BERBEL, Barcelona (ES)

(21) Appl. No.: 16/477,304

(22) PCT Filed: Jan. 15, 2018
(86) PCT No.: PCT/EP2018/050882

§ 371 Date: Jul. 11, 2019

(30) Foreign Application Priority Data
Jan. 13, 2017 (EP) 17382011.9

(51) Int. Cl. B01L 3/00; F16K 99/00

(52) U.S. Cl. CPC B01L 3/502738; F16K 99/0032; F16K 99/004; F16K 2099/0084; B01L 2300/1827; B01L 2400/0677; B01L 2300/0887

(57) ABSTRACT

A microfluidics valve comprises at least two substrates (1) between which there is at least a microchannel (5). It additionally comprises at least a barrier (4) of a meltable material, placed in the microchannel. The valve further comprises at least an optical heater (6) placed in correspondence with the barrier (4) and at least a section of one of the substrates (1), in correspondence with the optical heater (6), is transparent. The optical heater is a colored line that, when is illuminated with a light source, is heated and releases the heat to the barrier (4) thus melting the part of it that is closer to the line.

### OBJECT OF THE INVENTION

The present invention is enclosed in the technical field of the microfluidics valves. More specifically a multiple actuation light-addressable microfluidics valve comprising a barrier of a meltable material is described.

### BACKGROUND OF THE INVENTION

Phase-change paraffin wax valves have emerged in recent years as alternative to electromechanical or pneumatic valves in microfluidics. Among them, those based on the use of paraffin wax as flow plug have attracted considerable attention due to their simple operation and design as well as their latching capability.

The more important technical problems associated to this kind of valves is that most of these valves are single-use, show a slow response and require the challenging deposition of molten wax at specific locations within their microchannels.

Document WO2004042357 describes a microfluidic device comprising a heating element which transfers heat to a wax plug which is located between substrates covering a vertical distance. Afterwards, a pressure is applied at a side of the wax plug so the melted wax displaces, opening completely a passage between the substrates. For the closing of the device it is necessary to have a higher pressure in one of the sides of the passage so the wax is forced to return to its original position.

Document U.S. Pat. No. 4,949,742 describes a gas valve which is particularly useful in a laser gas fill system requiring repeated fillings. Includes a conduit positioned between high and low pressure gas regions and within the conduit is a restriction, and this restriction is closed by a meltable solid material. When the valve is to be opened, heat is applied to the meltable solid material causing at least some of the material to flow and allow the passage of gas from the higher pressure region to the lower pressure region. When the pressure between the two regions has substantially equalized surface tension associated with the restriction in the conduit pulls the liquefied material back into place to close and reseal the valve, at which point heat application is discontinued so that the material again becomes solid. The geometry of the restriction is such that all or substantially all of the liquid material will return essentially to its original position, allowing the valve to be used in repeated on/off cycles.

Document “Multiple actuation microvalves in wax Microfluidics, Lab Chip, 2016, 16, 3969” describes valves that use a first electrical heater to melt a small tunnel through a wax barrier and allow the passage of fluid when the pressure applied ejects the melted wax out of the barrier. Two more heaters in the valves are used to stop the passage of fluid by melting wax at both sides of the tunnel and refilling the tunnel with the melted wax. Wax-barrier valves using electrical heaters require at least one electrical connection per heater. In disposable lab-on-a-chip systems requiring high number of valves this involves including a connector with many pins to connect the chip to the driving circuits in the readout instrument. A chip with connector is more expensive and less reliable than a chip without connector.

### DESCRIPTION OF THE INVENTION

The object of the present invention is a microfluidics valve that is light-addressable and that is multiple actuated.

Said valve comprises at least a microchannel in which a barrier of a meltable material is placed. At the usual working temperature, the meltable material is blocking the passage of fluid through the microchannel.

In order to allow the fluid passage through the microchannel, the meltable material, has to be heated. To this end, the valve comprises at least an optical heater that is placed in correspondence to the barrier blocking the microchannel. The optical heater is placed in one of the substrates and projects from both sides of the barrier. The meltable material has low viscosity upon melting, so that it can be easily ejected out of the barrier by a pressure difference between both sides of the valve.

Preferably, the meltable material has a melting point of between 50° C. and 150 ° C., since meltable materials with lower melting points would melt in warm environments and meltable materials with higher melting points would require high quantities of energy for their actuation and would require substrates resistant to high temperatures.

Also, the meltable material is highly transparent to the light in some frequencies range so it does not melt directly when being irradiated by an external light source but when the heater transfers the heat.

Meltable materials with these properties include, but are not limited to, natural bees wax, paraffin wax, and wax-based hot melts.

Said optical heater is made of a photothermal material, that is, the material can absorb light energy in a range of frequencies and convert it to heat. So, when the optical heater is irradiated with an external light source its temperature increases rapidly. The valve comprises at least a section of one of the substrates which is transparent so the heater can receive the light of light source. The light source can be, for example, a LED light.

When the colored line receives the light, it accumulates heat and passes said heat to the barrier that is in contact with the optical heater thus creating a tunnel through the barrier along the microchannel. The tunnel has a smaller section than the barrier since only the meltable material which is in contact with the optical heater melts. When the meltable material of the barrier which is in contact with the optical heater is melted it is displaced to one of the ends of the microchannel so the section of the tunnel is left free for the fluid to pass through.

This feature allows fastening the opening operations of the valve. Furthermore, since less material is melted, less energy is needed for the opening of the valve and also the closing operations of the valve are performed faster.

In an embodiment of the invention, the valve is placed between two volumes which are at different pressure. When the heater is activated and melts the barrier, the difference in pressure between both volumes contributes to displace the melted material to one side of the barrier, allowing the passage of the fluids through it.

In order to close the valve, the pressure at both sides of the barrier has to be equalized and then the optical heater has to be activated. The meltable material of the barrier, preferably wax, near the optical heater is melted and refills the tunnel. Then, when the optical heater is disconnected, the meltable material solidifies, acting again as a barrier, blocking the microchannel.

In another embodiment of the invention, the microfluidics valve is used in lab-on-a-chip applications that use pressurized reservoirs as source of pressure for liquid movement. In those cases it cannot be assured an equalized pressure at both sides of the microchannel.

To solve this technical problem and provide a valve that can be used even when there is a pressure difference between both sides of the valve, in an embodiment of the invention, the valve comprises more than one heater. This embodiment of the valve can be used even in cases when pressurized reservoirs are used as source of pressure for liquid movement.

In this case, a first optical heater is placed in correspondence with the barrier, and two additional optical heaters are placed at both sides of the first optical heater.

The first optical heater is placed in the longitudinal direction of the barrier. It has to be long enough to project from each side of the barrier. This feature is important to assure that all the length of the barrier is melted. That assures that the tunnel connects both sides of the barrier and the fluid can pass through the valve. The additional optical heaters have to be short enough to not project out of the barrier at any point.

The first optical heater is a colored feature, that is, it absorbs most of the light power at a particular range of frequencies, and the additional optical heaters are colored features of colors different to the color of the first optical heater, that is, they absorb most of the light power at a different range of frequencies. An essential feature of the valve of this embodiment of the invention is that the colors of the first optical heater and of the additional optical heaters have to preferentially absorb light at different ranges of frequencies. Also, the light source that has to be used to heat a specific heater has to be of a color complementary to the color of the colored line of said heater, that is, it has to contain most of the power in the frequency range that are preferentially absorbed by said heater, and has to contain little power in the frequency range that the other heaters preferentially absorb.

The possibilities for using the proposed microfluidic valve are:
Flow control on disposable lab-on-a-chip systems: These valves allow easy implementation of reagent reservoirs integrated in the chip. The fluid is sealed in the reservoirs until the moment in which they have to be used. In that moment the valve is opened and the fluid exits the reservoir. Once enough liquid has exited the reservoir the valve can be closed until the next time the reagent is needed. For example, the reagent could be a rinsing solution that has to be used multiple times during an immunoassay implemented in a lab-on-a-chip.
Gas or liquid samplers: These valves allow a high integration in a small area (>100 valves per cm²) so they can be used to provide highly compact samplers and with low consumption. Each sample can be stored in an individual reservoir. This type of systems may be of interest for environmental control, industrial production, and for biomedical applications.
Pumps: In this case the system may comprise a chamber and two of these valves, one at the entrance and another one at the exit of the chamber. Controlling the aperture and closing of said valves, and the pressure inside the chamber, it can be used for the repeated generation of positive or negative pressure with which to produce movement of fluid in a microfluidic system. The sequence of each pumping cycle comprises the following steps:
   activating an optical heater inside the chamber so the air in the interior of the chamber is heated and the pressure there raises above the exterior air pressure;
   opening a first microchannel by heating a first barrier of a meltable material;
   closing the microchannel when enough quantity of compressed air has passed through the microchannel and the pressure inside the chamber has equalized the exterior air pressure;
   letting the air inside of the chamber to cool down until the pressure in the chamber lowers below the exterior air pressure;
   opening a second microchannel until enough quantity of air has passed through the microchannel and the pressure of the air in the interior of the channel and the pressure of the air and the exterior air pressure are equalized.

The pump can also be implemented by producing fluid flow with the compression or expansion of the chamber with an external mechanical force, and using the opening and closing of the valves to regulate the entrance and exit of the fluid in the chamber always in the same direction.

The microfluidic wax microvalve is thus light-actuated and allows multiple-actuation, presents a fast response and has a very low energy-consumption. This wax microvalve is also inherently latched in both open and close states.

In an exemplary embodiment of the invention the response of the valve is approximately 100 ms for the opening time and less than 500 ms for the closing time, the energy-consumption is less than 1 J and is leak-proof to at least 80 kPa. Additionally, the area occupied by the valve is of less than 1 mm² so an important application of the proposed valve is its use in samplers and dispensers comprising a plurality of equal valves.

The proposed valve is actuated by using at least a light source without requiring any electrical connection for the valve. The valve can be easily fabricated as a fully integrated element of wax microfluidic devices using a low-cost and fast prototyping process. Furthermore, the valve comprising an optical heater allows avoiding the use of additional electrical connections. The fabrication process of the valves and the samplers comprising a plurality of valves is simple and cheap.

The microfluidics valve described can be manufactured according to actual methods for the manufacture of microfluidic components. In an embodiment of the invention, the valve comprises two substrates which are joined, for example, by an adhesive. In another embodiment of the invention the valve comprises, between the substrates, an additional layer which is made of wax.

In an embodiment of the invention one of the substrates comprises a hole in order to allow easily placing the barrier of meltable material in its correct position. In the valve, the hole is placed facing the optical heater (the first optical heater in the embodiments in which also additional optical heaters are present) so when the meltable material (for example wax) is introduced through the hole it is placed in contact with the optical heater.

The microfluidic valves described here perform a reversible open-close behavior and show an extremely short response time. This is a result of the valve comprising an optical heater that only melts the part of the barrier which is in contact with it thus creating a tunnel (of a smaller section than the microchannel) for the passage of the fluid. These valves have a lower energy consumption compared to the plug-type wax valve of the state of the art.

Another important advantage of the proposed valves is that the warm-up is made without contact. While in the electrical valves connections are needed (at least one per valve) in the present invention the optical heater allows heating the barrier of meltable material without contact.

Furthermore, these valves can also be used for the implementation of bead-based assays inside lab-on-a-chip devices. Beads having a diameter larger than the height of the tunnel created through the barrier of meltable material cannot pass through the opened valves. This allows the retention of beads in a microchannel and the exposure of the beads to different liquids being flown through the microchannel. For example, an Enzyme Linked Immunosorbent Assay (ELISA assay) can be carried out at the surface of antibody-functionalized beads by consecutively flowing a liquid sample and different reagents and washing solutions through the microchannel.

Furthermore, the height of the tunnel created through the barrier can also be made larger than the beads diameter by applying a longer light pulse to the optical heater. This enables moving the beads from a first microchannel to a second microchannel during the ELISA assay. For example, it enables performing the antigen-antibody immune reactions in a first microchannel and the enzymatic reaction in a second microchannel. Performing the enzymatic reaction in a second clean microchannel avoids the interference of enzyme-labelled antibodies nonspecifically absorbed at the surface of the microchannel during the immune reactions. This is an important advantage because it makes unnecessary the blocking of the microchannels surfaces to avoid nonspecific absorptions, and hence, simplifies the fabrication of the lab-on-a-chip device. The same advantage applies for lab-on-a-chip devices implementing other types of assays using labelled molecules. For example Enzyme-Linked Oligosorbent Assays (ELOSA), Enzyme-Linked Oligonucleotide Assays (ELONA), Immunofluorescence Assays (IFA), and Chemiluminescence immunoassays (CLIA).

### DESCRIPTION OF THE DRAWINGS

To complement the description being made and in order to aid towards a better understanding of the characteristics of the invention, in accordance with a preferred example of practical embodiment thereof, a set of drawings is attached as an integral part of said description wherein, with illustrative and non-limiting character, the following has been represented:

FIG. 1a.—Shows a perspective view of an embodiment of the microfluidic wax valve.

FIG. 1b.—Shows the microfluidic valve of FIG. 1a with the barrier of meltable material.

FIG. 1c.—Shows a section view of the microfluidics valve of FIG. 1b.

FIG. 2a.—Shows a perspective view of another embodiment of the microfluidics valve.

FIG. 2b.—Shows an exploded view of the microfluidics valve of FIG. 2a.

FIG. 3.—Shows the operation of the microfluidics valve when it is being opened.

FIG. 4.—Shows the operation of the microfluidics valve when it is being closed.

FIG. 5a.—Shows a perspective view of a different embodiment of the microfluidics valve.

FIG. 5b.—Shows the microfluidic valve of FIG. 5a with the barrier of meltable material.

FIG. 5c.—Shows a section view of the microfluidics valve of FIG. 5b.

FIG. 6a-6b.—Shows the opening process of the microfluidics valve of the embodiment of FIGS. 5a-c.

FIGS. 7a-7c.—Shows the closing process of the microfluidics valve of the embodiments of FIGS. 5a-5c.

FIG. 8.—Shows a microfluidic chip comprising five valves.

FIGS. 9a-f.—Show an schematic representation of a microfluidic chip operation during a bead-based immunoassay.

### PREFERRED EMBODIMENT OF THE INVENTION

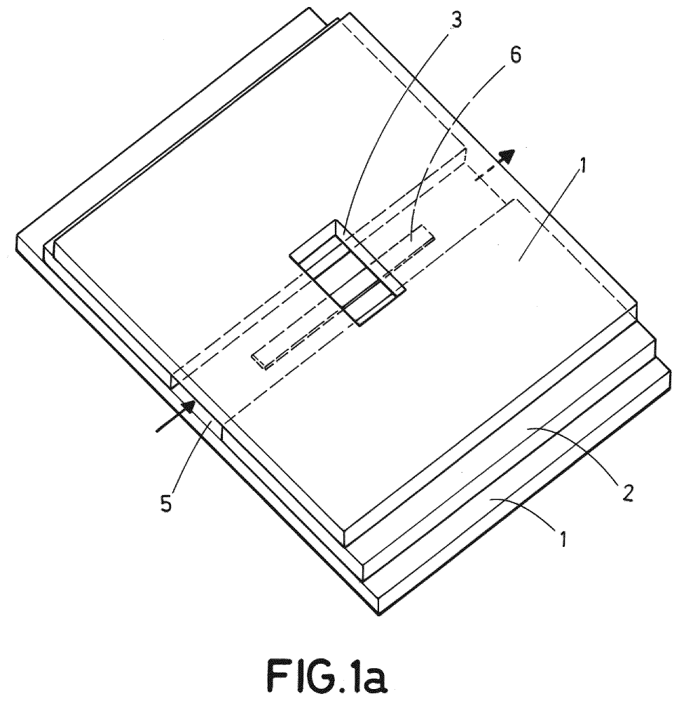

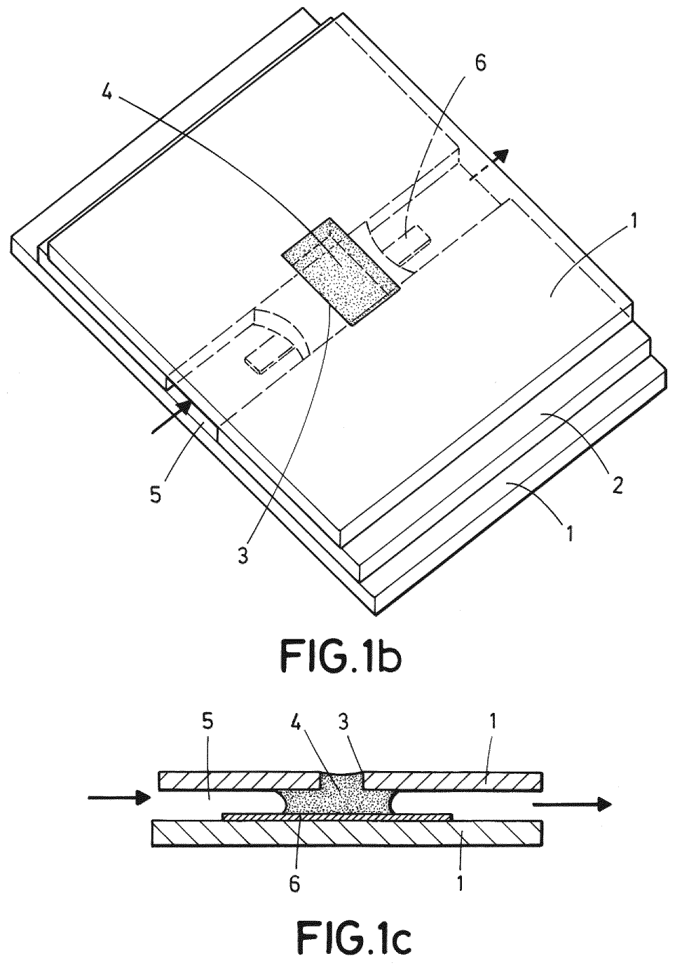

Following is a description, with the help of FIGS. 1 to 9, of some examples of embodiments of the present invention.

In FIG. 1a it is shown a perspective view of a microfluidics valve according to one embodiment of the invention. In said embodiment the valve comprises two substrates (1) between which at least a microchannel (5) is formed. The substrates (1) can be joined by an adhesive (2).

The valve also comprises at least an optical heater (6) as shown in said figure. In order to allow the heating of the optical heater (6), at least a section of one of the substrates (1) is transparent.

Furthermore, as shown in FIG. 1b, the valve of the invention also comprises at least a barrier (4) of meltable material, placed in the microchannel (5), blocking said microchannel (5). As can be seen in the figure the optical heater (6) is placed in the longitudinal direction of the microchannel (5) and, in said direction, projects from both sides of the barrier (4).

In FIG. 1c it is shown a section view of the microfluidics valve. The section has been made in correspondence with the microchannel (5) so the microchannel (5) and the barrier (4) blocking said microchannel (4) are appreciated. The direction of the fluid through the valve has also been represented with arrows.

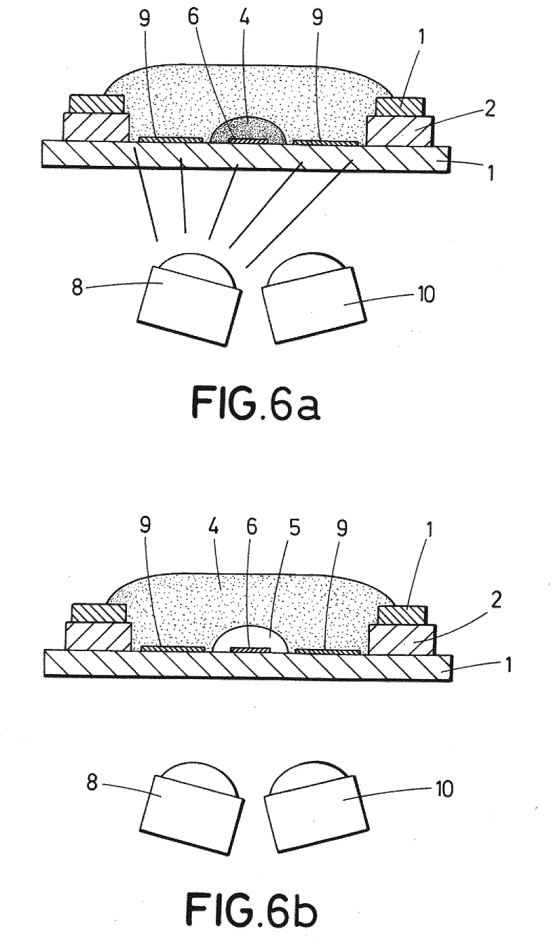

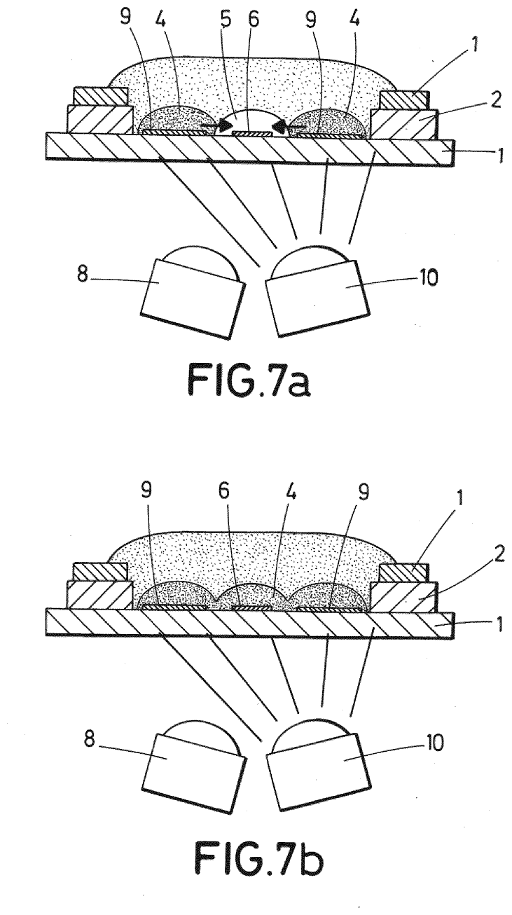

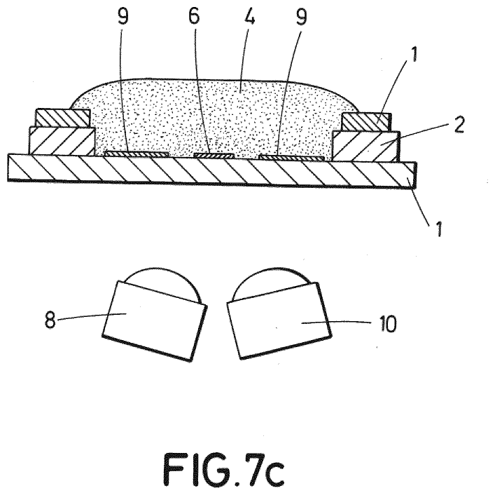

By actuating the optical heaters (6) corresponding to predetermined microchannels (5) the barriers (4) of said microchannels (5) are partially melted and tunnels (11) are opened to allow the fluid to pass through them. To actuate the optical heaters (6) an external light is focused on them. In this way the optical heaters (6) are heated and they transfer the heat to the meltable material of the barrier (4) which is contact with said optical heaters (6). In FIGS. 6b and 7a the tunnel (11) formed in the barrier (4) placed in the microchannel (5) can be appreciated.

In the embodiments shown in the figures, the optical heater (6) is a colored line. The light used to actuate the optical heaters (6) has to be of a color complementary to the color of the optical heater (6). That is, if the optical heater (6) absorbs most of the light power at a particular range of frequencies, the light source has to have enough optical power at the same range of frequencies to assure the correct functioning of the valve.

In the embodiment shown in FIGS. 1a-1c the microfluidics valve comprises at least a hole (3) in correspondence with the microchannel (5) and facing the optical heater (6).

This embodiment of FIGS. 1a-1c allows easily placing the barrier (4) of meltable material on its correct position. In valves of the state of the art the meltable material had to be melted and then introduced into the microchannel and displaced until its final position. These solutions of the state of the art need a lot of time for the manufacture, part of the barrier can be finally placed in a position which is not the correct final position, lot of resources are need to place the barrier (it has to be melt, pressure has to be applied to displace it, etc.) and external tools have to be used.

Also, this embodiment comprising the hole (3) cannot be used in the solutions of the state of the art because, in those valves the meltable material barrier (4) blocking the microchannel (5) is totally melted for the passing the fluids through the microchannel (5). In those cases, when melting the barrier, the meltable material forming the barrier (4) would exit through the hole (3) and it would be impossible to send the material back to the microchannel (5) to close the valve when needed, or to avoid the scape of liquid through the hole (3). In an embodiment of the invention the meltable material is wax.

In the present invention, when the optical heater (6) is actuated, only a small part of the barrier (4) is heated (only the part in contact with the optical heater (6)) so only a tunnel (11) of a smaller section than the microchannel (5) is opened for the passage of the fluid.

In an embodiment of the invention, the valve is to be installed between a first volume at initially higher pressure and a second volume at initially lower pressure in order to use said pressure during the opening of the valve to displace the melted barrier.

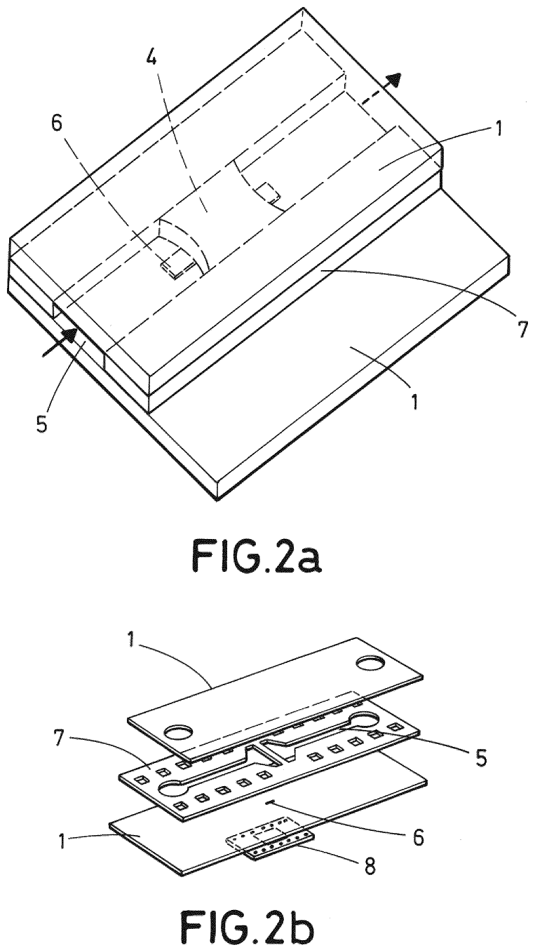

In FIGS. 2a and 2b another embodiment of the invention is shown. In this case the valve comprises two substrates (1) with a wax layer (7) placed between them.

In the example of FIG. 2b, the valve structure comprises a 500 μm-length barrier (4) located in a microchannel (5) at the entrance of a chamber. The line printed on the substrate, which in an embodiment of the invention is black, is the optical heater (6) and is positioned perpendicular to the barrier (4) extending on both sides of the valve structure. This valve is designed for opening when a pressure difference is applied across the barrier (4) and for closing when there is no pressure. Both opening and closing of the valve occurred when the meltable material (for example wax) of the barrier (4) is melted using the heat released by the printed line upon light source (8) irradiation.

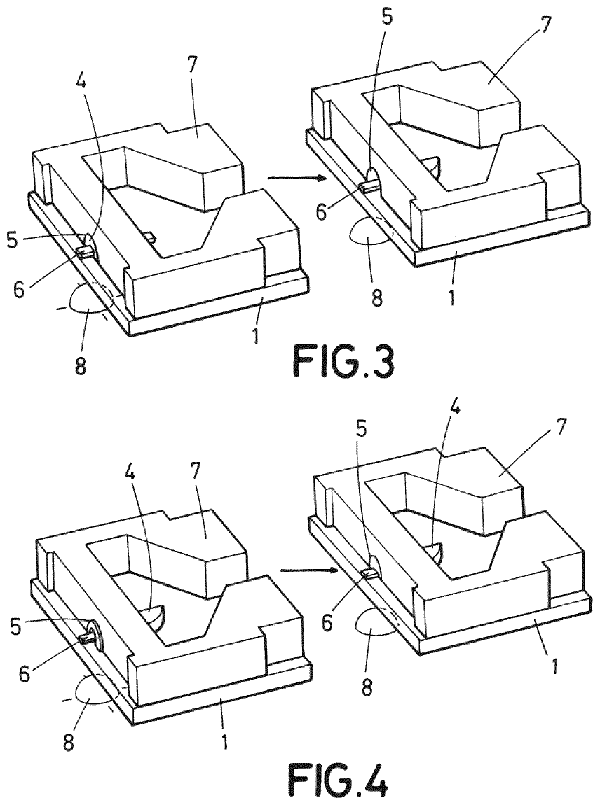

As represented in FIG. 3, the operation of the valve when it is being opened comprises a step of irradiating the optical heater (6) with a light source (8). In the first part of the figure a closed valve has been represented. It can be appreciated how the microchannel (5) of the valve is blocked with a barrier (4). Said barrier (4) is, in turn, placed in correspondence with the optical heater (6). As can be seen in the second part of the figure, when the light source (8) is applied and the optical heater (6) melts the barrier (4) which, in this case, is ejected to the interior of the chamber thus creating a tunnel (11) in the barrier (4) through which the fluid can pass.

In FIG. 4 it is represented the operation of the valve when it is being closed. In this case the original situation of the valve is with the barrier (4) having a tunnel. In the second part of the figure it can be seen how, when the optical heater (6) is activated again, the meltable material (for example wax) returns to its original position in the microchannel (5) and blocks it. Once the optical heater (6) is turned off, the meltable material (for example wax) solidifies and the valve remains permanently closed.

Performance of the microfluidics valves in an exemplary embodiment of the invention is characterized in both air and water under different experimental conditions. In both cases a minimum pressure drop of 3 kPa is required for a successful valve opening. The valve exhibits reversible open-close behavior for up to 30 actuation cycles in air (50 kPa) and 15 in water (25 kPa).

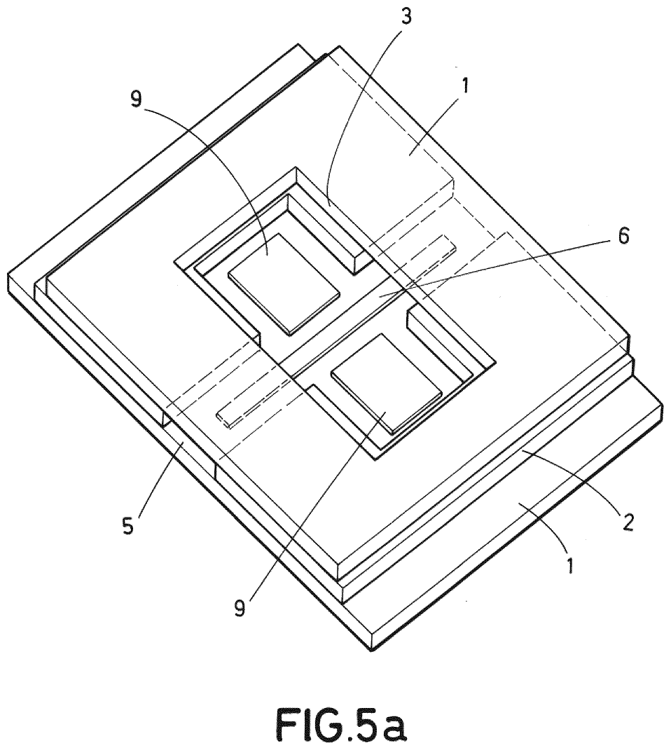

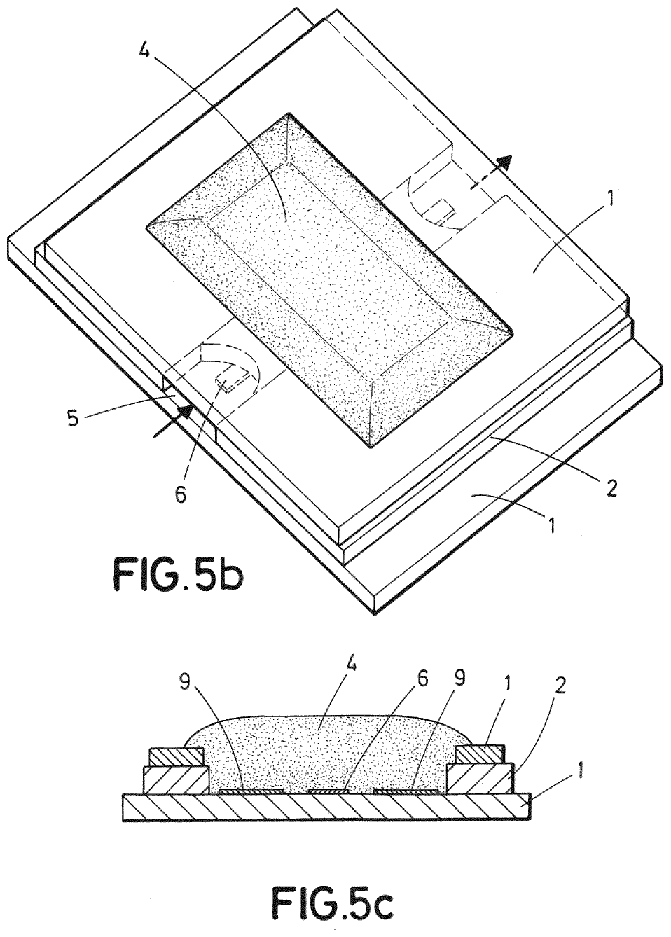

In FIGS. 5a-c it is represented another embodiment of the invention. In this case, the microfluidics valve is designed to be used in applications requiring closure of the valve while there is a fluid flow through it, and therefore pressure difference across it.

As previously described, in cases in which the valve has to be used in applications in which a difference of pressure at both sides of the valve is present, additional optical heaters are needed.

In this case it is represented a valve which comprises two substrates (1) joined by an adhesive (2). Between the substrates (1) it is formed at least a microchannel (5) and a barrier (4) of a meltable material is placed blocking said microchannel (5), as in the embodiment of FIGS. 1a-c. The valve also comprises a hole (3) in correspondence with the microchannel (5) for the passing of the meltable material for forming the barrier (4) when manufacturing the valve.

In FIGS. 5a-5c it can be appreciated the essential feature of this embodiment of the invention which is that the microfluidics valve, in this case, comprises a plurality of heaters. In this case, a first optical heater (6) is placed in correspondence with the barrier (4), in longitudinal direction of the barrier (4) and projecting from its sides.

In this embodiment, there is also at least an additional optical heater (9) placed at one side of the first heater (6). Preferably, as represented in the figures, there are two additional optical heaters (9) which are placed each one at each side of the first heater (6). Said additional optical heaters (9) are contained in the space of the microchannel (5) occupied by the barrier (4), embedded in said barrier (4). That is to say, the additional optical heaters (9) do not project out of the barrier (4) at any point.

The first optical heater (6) and the additional optical heaters (9) are photothermal colored features which are colored in different colors, complementary colors, that is, absorb light power at different frequency ranges. In an exemplary embodiment of the invention the first optical heater (6) is a magenta line and the additional optical heaters (9) are cyan lines. Those colors have been selected because they adsorb light at different frequencies, the magenta line absorbing green light, that is light of wavelength around 530 nanometers and the cyan line absorbing red light, that is, light of wavelength around 630 nanometers, so it is possible to not actuate the additional optical heaters when actuating the first optical heater and viceversa.

In this case, to open the valve, since the first optical heater (6) is magenta, a green light (8) is applied in order to heat the first optical heater (6) without heating the additional heaters, as can be seen in FIGS. 6a-b.

In order to close the valve, an additional light source (10) is used. In this case the additional optical heaters (9) are cyan so the additional light source (10) is red. When the additional light source actuates the optical heaters (9), the meltable material in contact with those additional optical heaters (9) is melted and displaces to the tunnel (11) where it becomes solid, creating again the barrier (4) and blocking the microchannel (5), as can be seen in FIGS. 7a-c.

This valve notably improves current drawbacks of paraffin wax microvalves in terms of response time, energy consumption, multiple actuation and complexity of the fabrication processes. Furthermore, the microfluidic technology described here is highly promising for mass production of fully-integrated disposable lab-on-a-chip devices.

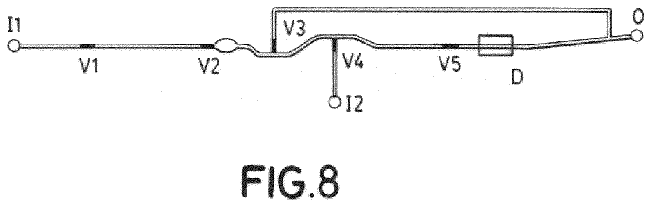

FIG. 8 shows a microfluidic chip, comprising five microvalves (V1-V5) as previously described, designed to perform a simple bead-based enzymatic immunoassay. It also comprises two inlets (I) and an outlet (O). The chip is composed by one structured double-sided adhesive layer sandwiched between two transparent polyester films. The bottom transparency film incorporates the printed black ink lines that function as photo-thermal heaters for wax valve actuation. Wax valves are easily fabricated at the desired locations within the microchannels by simple deposition of solid wax on the substrate before the chip assembly followed by heating step. External white LEDs are used as light source for valve actuation. An LED-photodetector pair is used for absorbance measurement in the detection microchannel.

In an example of embodiment, a negative pressure of 10 kPa is applied at the outlet (O) for valve opening. Valve closing is performed with no pressure applied. The valves can be either partially (and reversibly) or fully (irreversibly) opened, depending on the duration of the actuation light pulse.

During valve (V1-V5) partial opening, wax in contact with the heated black line is melted and ejected from the barrier (4), thus creating a tunnel. When closing (no pressure applied) the wax around the heater (6) melts and refills the tunnel. Valve V2 to be opened irreversibly requires a channel (5) widening to trap the melt wax.

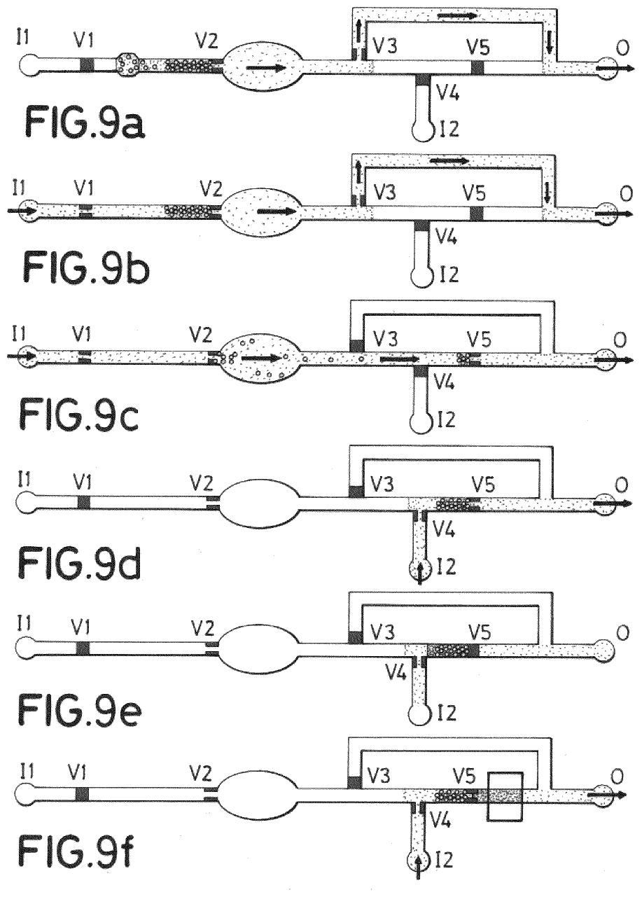

A simple immunoassay was performed on-chip following the steps shown in FIGS. 9a-f. Anti-rabbit IgG antibodies labeled with horseradish peroxidase were successfully detected using rabbit IgG functionalized (and BSA blocked) polystyrene microbeads (30 μm diameter) and 3,3′,5,5′-Tetramethylbenzidine (TMB) as enzymatic substrate.

In FIGS. 9a-f are depicted the following steps of the chip operation: the loading of microbeads (which is made in a microbeads loading port (MLP)) (FIG. 9a), an immunoassay (sample, immunoreagents, and washing solutions injected from inlet I1) (FIG. 9b), microbeads displacement (FIG. 9c), enzymatic substrate injection from inlet I2 (FIG. 9d), enzymatic reaction (FIG. 9e), detection (which is made in a detection point (D)) (FIG. 9f)).

The size of the tunnel in partially open valves is small enough to allow liquid flow while retaining the microbeads. Fully opened valves (V2) allow the passage of the microbeads. The movement of microbeads enabled performing the enzymatic reaction in a clean channel, which yielded an order of magnitude improvement in the limit of detection.

1. Microfluidics valve which comprises:
at least two substrates (1) between which at least a microchannel (5) is formed; and
at least a barrier (4) of a meltable material, placed in the microchannel (5), blocking said microchannel (5);
characterized in that:
it comprises at least an optical heater (6) configured to melt the barrier (4) and which is placed in the longitudinal direction of the microchannel (5) projecting from both sides of the barrier (4);
at least a section of one of the substrates (1) is transparent.

2. Microfluidics valve according to claim 1 characterized in that the optical heater (6) is placed in one of the substrates (1) and is facing the barrier (4).

3. Microfluidics valve according to claim 2 characterized in that the optical heater (6) is in contact with the barrier (4).

4. Microfluidics valve according to claim 1 characterized in that the optical heater (6) is a feature made of a photothermal material that can absorb light energy in a range of frequencies.

5. Microfluidics valve according to claim 1 characterized in that the optical heater (6) is a printed dark colored line placed in one of the substrates (1).

6. Microfluidics valve according to claim 1 characterized in that one of the substrates comprises at least a hole (3) in correspondence with the microchannel (5) and facing the optical heater (6).

7. Microfluidics valve according to claim 1 characterized in that it comprises a first optical heater (6) placed in the microchannel (5) in correspondence with the barrier (4) and at least an additional optical heater (9) placed in one side of the first optical heater (6).

8. Microfluidics valve according to claim 7 characterized in that it comprises two additional optical heaters (9) placed each at one side of the first optical heater (6).

9. Microfluidics valve according to claim 7 characterized in that the additional optical heaters (9) do not project out of the barrier (4) at any point.

10. Microfluidics valve according to claim 7 characterized in that the first optical heater and the additional optical heaters are photothermal colored features of different colors.

11. Microfluidics valve according to claim 7 characterized in that the first optical heater (6) and the additional optical heaters (9) are colored features of complementary colors.

12. Microfluidics valve according to claim 7 characterized in that the first optical heater (6) is a magenta line and the additional optical heaters (9) are cyan lines.

13. Microfluidics valve according to claim 1 characterized in that the meltable material is wax.
